(19) United States
(12) Patent Application Publication
(10) Pub. No.: US 2002/0197492 A1
(43) Pub. Date: Dec. 26, 2002

(54) Selective plating on plastic components

(76) Inventors: Ling Hao, Grand Rapids, MI (US); Lawrence P. Donovan III, Lowell, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/888,910

(22) Filed: Jun. 25, 2001

(51) Int. Cl. B32B 15/04; C25D 5/02

(52) U.S. Cl. 428/457; 205/118; 428/901

(57) ABSTRACT

A process of selectively plating a metal pattern on the surface of a plastic component allows intricate and/or fine patterns of metal to be precisely electroplated onto either a two-dimensional or three-dimensional contoured surface of a plastic article or substrate. The selective metal plating may be either a decorative pattern or a functional pattern, such as for an electrical circuit. The process generally comprises electrolessly depositing a metal coating on the surface of a plastic component, depositing a photoresist coating over the electrolessly deposited metal, imaging and developing the photoresist coating to form a desired patterned photoresist, electroplating a metal on the electrolessly deposited metal that is exposed through the developed photoresist pattern, and stripping the cured photoresist coating and electrolessly deposited metal underneath the cured photoresist coating without damaging the decorative or functional electroplating.

### FIELD OF THE INVENTION

This invention relates to metal plating on plastic articles and more particularly to a process for depositing a metal plating on selected portions of the surface of a plastic substrate.

### BACKGROUND OF THE INVENTION

Selective metallization procedures for electronic manufacture are known in the art. A process for plasma etching a substrate is disclosed in U.S. Pat. No. 5,053,318. In accordance with the processes of this patent, a suitable substrate, such as an electronic base material, is coated with a radiation-sensitive photoresist composition. The photoresist coating is then pattern imaged. Thereafter, and before development, the surface of the photoresist is contacted with an electroless plating catalyst. The photoresist coating is then contacted with a developer whereby plating catalyst absorbed onto developer soluble portions of the coating is removed with solubilized photoresist. Plating catalyst remains on those portions of the coating that are insoluble in developer. This results in formation of a catalytic coating in an image pattern that conforms to the developed photoresist coating. The imaged catalytic coating is then metallized by contact with an electroless plating solution to form a thin metallic layer. The entire article is then subjected to plasma etching. The thin metallic layer functions as an etch barrier whereby the substrate is altered in a reverse image of the metallic layer. The remaining photoresist coating with the metallic layer may then be removed by contact with a photoresist stripper.

A selective metallization process for manufacture of printed circuit boards is disclosed in U.S. Pat. No. 5,158,860. In the process of this patent, a substrate is coated with a photoresist layer. The photoresist is then pattern imaged and developed to form a relief image. The article is then contacted with an electroless plating catalyst. The catalyst is adsorbed onto all surfaces with which it comes into contact, i.e., the side-walls of the photoresist and the underlying substrate. The top surface of the photoresist is then flood exposed. The catalytic layer adsorbed on the top surface of the photoresist coating is then removed by surface development. Catalyst remains in surfaces not exposed to activating radiation, i.e., the recesses within the photoresist relief image and on the bared substrate surface. Electroless metal may then be deposited over the catalyzed surfaces whereby the walls of the relief image and the substrate become metallized. With continued plating, the entire volume of the recesses may be filled with deposited metal.

Another approach to selective metallization is described in U.S. Pat. No. 5,079,600. In accordance with this patent, metal pathways are formed on the surface of a substrate by a process that comprises formation of a self-assembled monomolecular radiation reactive layer. Preferred materials are characterized by a polar end, a non-polar opposite end and a reactive moiety at or near its terminus, and an intermediate region typically composed of saturated or unsaturated hydrocarbon chains. Organosilanes are a preferred class of materials. Thereafter, the reactivity of the terminus reactive groups on the film are altered in a selective pattern by exposure to imaged radiation to cause photolytic cleavage or transformation of the reactive terminus groups. Since irradiation is in a pattern, the reactivity of the monomolecular layer is altered in a corresponding image pattern. In one embodiment, differential reactivity comprises creation of hydrophobic-hydrophilic regions in the pattern. The surface is then contacted with an electroless plating catalyst. Since the catalyst is an aqueous based material, it will selectively absorb on the hydrophilic portions of the monomolecular layer. The substrate may then be metal plated by contact with an electroless plating solution with metal depositing only over catalytic sites in the desired image pattern.

European Patent Application, publication No. 0,510,711, discloses a process for selective metallization comprises the steps of formation of a layer over a substrate having a terminus group capable of bonding with a catalyst precursor. Preferably, the terminus group is a metal ion binding or ligating group, and the layer is a self-assembled film having a terminus ligating group. Following formation of the ligating layer and imaging of the same using procedures analogous to the procedures of the above-cited U.S. Pat. No. 5,079,600, the surface contains regions having reactive ligand groups in a desired image pattern. This layer is then contacted with a catalyst precursor solution such as a solution of palladium ions. The ions bond with the ligating groups of the ligating layer. Subsequent contact of the layer with an electroless metal deposition of metal onto the ligating layer in the desired pattern.

Another process for selective metallization of a substrate is disclosed in U.S. Pat. No. 5,510,216. This process comprises the steps of forming a ligating layer over a substrate such as an electronic base material, coating the layer with an organic coating, especially a photoresist composition, imaging the photoresist layer to provide a relief image—i.e., one having recesses therein open to the substrate, thus baring the ligating layer over the bared substrate, contact of the substrate with a catalytic precursor to bond the precursor to the exposed ligating groups to form a catalytic surface in a desired image pattern and metal deposition to form a metal layer in a desired pattern.

U.S. Pat. No. 4,869,940 describes a process for providing a decorative metal pattern on a substrate. The process generally includes steps of laminating a metal foil to a plastic substrate, selectively coating the metal foil with a protective material, removing the uncoated metal surface by dissolving in an acid solution, and optionally removing the protective material to expose a decorative metallic pattern.

All of the above technologies are limited to two-dimensional patterns.

### SUMMARY OF THE INVENTION

The invention provides an improved process for forming one or more decorative and/or functional metal patterns on a plastic substrate. The process allows intricate and/or fine patterns of metal to be precisely electroplated onto either two-dimensional or three-dimensional contoured surfaces of a plastic article. The process generally includes steps of depositing an electroless metal coating on a plastic substrate, depositing a photoresist coating on the electrolessly deposited metal coating, imaging the photoresist coating with a desired pattern, developing the imaged photoresist coating to expose areas of the electrolessly deposited metal coating through the patterned photoresist coating, and plating (e.g., electroplating or electroless plating) a metal onto the electrolessly deposited metal coating that is exposed through the patterned photoresist coating.

Decorative applications for the invention include plastic housings for various electronic devices, and functional applications include electrical circuits that are disposed on three-dimensional circuit carriers.

These and other features, advantages and objects of the present invention will be further understood and appreciated by those skilled in the art by reference to the following specification and claims.

### DESCRIPTION OF THE PREFERRED EMBODIMENTS

The selective plating process of this invention generally comprises conditioning the surface of a plastic article for electroless deposition of a metal coating, electroless deposition of the metal coating, application of a photoresist coating over the electrolessly deposited metal coating, imaging of the photoresist coating, developing of the imaged photoresist coating to form a patterned photoresist coating, electroplating the areas of the electrolessly deposited metal coating that are exposed through the patterned photoresist coating, and removing the developed photoresist and the areas of the electrolessly deposited metal coating that were underneath the patterned photoresist. The result is a plastic article having metal selectively deposited in a desired pattern on the surface of the plastic article. The metal plating pattern can be a decorative pattern or a functional pattern such as for an electrical circuit.

Commercialized conditioning, etching, neutralizing and activating treatments may be used to generate a sufficiently hydrophilic and active surface on plastic parts for electroless metal (e.g., copper or nickel) deposition. The most appropriate procedures and operational parameters for conditioning the surfaces of a plastic article for electroless deposition are dependent on the plastic material on which the electroless metal coating is to be deposited. For example, about 4 to about 10 minutes of etching in a chromic acid/sulfuric solution is suggested for acrylonitrile-butadiene-styrene (ABS) copolymers, whereas about 10 minutes of conditioning in an organic solvent solution is suggested for polycarbonate materials, and about 30 seconds to about 2 minutes of conditioning in an organic solvent solution and subsequent etching for about 10 minutes in chromic/sulfuric acid is suggested for PC/ABS materials. The conditioning and/or etching treatments convert hydrophobic plastic surfaces to hydrophilic surfaces. Neutralization eliminates hexavalent chromium ion residue resulting from the etching in the chromic acid solution. Activation imparts a catalytic property to the plastic surface so that electroless deposition of copper or other metal (e.g., nickel) can efficiently proceed during full scale commercial production of components. Appropriate procedures for preparing a variety of plastic substrates for electroless deposition of a metal coating are well known in the art and literature. Suitable plastic substrates include ABS, PC, PC/ABS blends and modified poly(phenylene oxide).

A commercialized electroless metal deposition may be utilized to deposit a continuous, uniformly thin film or coating of metal (e.g., copper or nickel) on the surface of a plastic article that has been appropriately conditioned. A suitable thickness for the electrolessly deposited coating is from about 12 micro-inches to about 75 micro-inches (0.3 micrometers to 1.9 micrometers). Preferably, the thickness of the electrolessly deposited metal coating is at least about 40 micro-inches (1.0 micrometers), more preferably at least 60 micro-inches (1.5 micrometers), in order to achieve uniform and consistent quality of the electrodeposited coating(s) during subsequent processing.

An advantage of electroless metal deposition technique is that it can be used to economically deposit an electrically conductive coating to a uniform thickness on a plastic article having a three-dimensional contoured surface. Forming an electrically conductive metal coating having a uniform thickness on a three-dimensional contoured plastic substrate is more difficult and expensive using other techniques such as chemical vapor deposition.

Application of the photoresist coating may be achieved using conventional techniques, including spin-coating, extrusion coating, chemical vapor deposition, electrophoretic deposition, etc. Electrophoretic deposition of the photoresist coating is preferred, especially when a non-planar substrate is to be coated. Suitable commercially available photoresists that can be electrophoretically deposited on a conductive substrate (i.e., the electrolessly deposited metal coating) are marketed by the Shipley Company of Marlborough, Mass. Desirably, the photoresist coating has a uniform thickness and is free of pinholes or other discontinuities.

A suitable bath composition for electrophoretically depositing a photoresist on a conductive substrate in the process of this invention may have a solids content (polymer content) of from about 10% to about 12% by weight, an organic solvent content of from about 10% to about 12% by weight, and contain about 0.015 N to about 0.025 N organic acid (e.g., lactic acid, citric acid, maleic acid, etc.). The bath should typically have a conductivity of from about 250 μS/cm to about 350 μS/cm. The electrophoretic deposition operation is preferably conducted with the bath at a temperature of from about 100° F. to about 108° F.

The electrophoretic photoresist bath or emulsion includes a polymer, a photoinitiator, and a source of unsaturation for initiating a cross-linking reaction. The photoresist composition also includes a carrier group that becomes positively or negatively charged upon contact with either an acid or a base. Depending on the composition of the carrier group and the bias applied by the voltage source, the carrier group causes the photoresist to coat onto the electrolessly deposited metal. Process parameters such as voltage, current, photoresist composition, temperature and electrode size and spacing are controlled to deposit a thin uniform layer of photoresist on the electrolessly deposited metal coating.

Suitable addition polymers include carrier groups which are prepared from monomers having ethylenic unsaturation, for example acrylic and other vinyl polymers. The carrier group of the polymer will become either negatively or positively charged upon contact with either a base or an acid. Negatively charged carrier groups, i.e., anaphoretic, will cause the polymer to be deposited upon a positively charged conductive layer. Polymers containing positively charged carriers groups, i.e., cathaphoretic, will be deposited upon a negatively charged conductive layer. Exemplary negative carrier groups include carboxylic acid groups. Exemplary positive carrier groups include sulfonium groups, sulfoxonium groups, and quaternary ammonium groups. Other groups, such as amine groups, which will become positively charged upon reaction with an acid, for example, monocarboxylic acids, hydrochloric acid, and phosphoric acid, are also suitable for use in the process of the present invention.

Compositions or emulsions which are formed by mixing a polymer containing carrier groups with at least one unsaturated monomer and a photoinitiator are preferred. The polymer of such compositions or emulsions are capable of being polymerized into a cross-linked polymer upon being exposed to actinic radiation. Suitable unsaturated monomers are those having two or more unsaturated groups attached to the same molecule, such as multifunctional monomers having two or more acrylate or methacrylate groups attached thereto.

Photoinitiators which are suitable for use in the composition or emulsion are amines, azo compounds, oximes, sulfur-containing compounds, organic carbonyl compounds, metallic salts and complexes, polynuclear compounds and quinones.

The photoresist solution or emulsion may be formed by mixing an aqueous polymer solution or emulsion with a suitable unsaturated monomer and thereafter adding a photoinitiator which is dissolved in a suitable solvent. An acid to protonate the carrier groups of the polymer may be added to the mixture. Upon complete mixing, water may also be added. The resultant emulsion can be diluted by further addition of water to adjust the solids content as required.

Coalescing agents, stabilizing agents or film modifiers, and dyes can also be included with the photoresist emulsion. One suitable coalescing agent is propylene glycol monomethyl ether which may be included in an amount up to 25% by weight, typically about 4-6% by weight. Stabilizing agents can also be added to prevent premature cross-linking of the monomers or polymers. Exemplary stabilizing agents include hydroquinine and phenothiazine, which may be included in an amount up to about 3% by weight, typically between 0.3% and 0.5% by weight. Exemplary dyes that may be added include triarylmethane dyes such as methylviolet added in an amount less than 1% by weight of the emulsion solids.

An article that has been electrolessly coated with a metal is submerged within an electrolytic bath containing a suitable electrophoretic photoresist emulsion. In addition, the bath includes an electrode. The electrically conductive electrolessly deposited metal layer coated on the article is electrically connected by suitable circuits to a voltage source.

The surface area of the electrode is desirably at least equal to or greater than the surface area of the electrolessly deposited metal coating to provide a substantially uniform current distribution from the electrode to the metal coating. The metal coating can be biased to a positive or negative electrical potential depending on the type of carrier group used to formulate the photoresist bath. The electrical bias attracts the carrier group to the metal coating and forms a uniformly thin layer of photoresist over the metal coating.

It may be helpful to vibrate the metal-coated article during the photoresist deposition process to displace bubbles that can cause pinholes in the deposited photoresist.

A plurality of constant voltages may be applied to the electrolytic cell, starting at about 70 volts and ending at about 100 volts or higher. A pulsing current will be observed and the current drops rapidly with time due to the growth of non-conductive photoresist coating thickness on the surface of the article, and approaches zero in from about 30 seconds to about 60 seconds. A 10-volt increment may be applied each time to the preceding voltage after the current reading approaches zero. The ending voltage may be repeatedly imposed to ensure the production of a pinhole-free photoresist coating.

The thickness of the photoresist coating varies depending on the bath composition, temperature, ending voltage and coating time. However, typical photoresist coating thicknesses may range from about 0.5 micrometers to about 20 micrometers.

Although other techniques may be used for depositing a photoresist layer on the electrolessly deposited metal coating, electrophoretic deposition is particularly useful for consistently depositing a uniformly thin photoresist layer on an article having a three-dimensional contoured surface.

After the photoresist coating has been applied, the coated article is rinsed and dried. Drying may be done in an oven with particle-free warm air at 80-100° F. for 10-15 minutes, followed by ramping the temperature at a rate of about 20° F./minute to about 160-170° F. and holding for two minutes at that temperature. This drying procedure minimizes inclusion of water and solvent in the photoresist coating.

Following the drying, the photoresist-coated article may be allowed to cool to ambient temperature before the photoresist coating is imaged. Imaging of the photoresist coating involves selective exposure of the areas of the photoresist coating to radiant energy, such as ultraviolet light, to form a pattern in the photoresist coating that can be developed. Either a positive or negative photoresist may be used. If a positive photoresist is used, the areas of the photoresist coating that are exposed to the radiation become selectively soluble in a particular developer solvent while the unexposed areas remain insoluble to the developer. For a negative photoresist, the unexposed areas remain soluble in a developer while the exposed areas become insoluble to the developer.

Imaging of the photoresist can be achieved by directing radiation toward the photoresist coating through a mask having areas that are transparent to the radiation and other areas that prevent transmission of the radiation, wherein the transparent and non-transmissive areas define the desired pattern that is to be replicated on the photoresist-coated article. Direct writing using electron beam patterning or a laser pattern writing system may also be used for imaging the photoresist coating. As another alternative, a three-dimensional imaging system comprising a three-dimensional master pattern, an afocal lens and a radiation source that are relatively disposed to project a desired image pattern on a predefined three-dimensional surface may be used to image the photoresist coating.

Although other techniques, such as those mentioned above, may be employed for imaging the photoresist coating, a preferred technique for imaging the photoresist coating on various articles, including planar articles, curved articles and articles having complex three-dimensional shapes, involves use of conformal two- or three-dimensional masks that may be held in place using a vacuum system. For a three-dimensional surface, a pre-thermally formed mask or a mask that is thermally formed on the part is used to conformally cover the photoresist-coated article. A vacuum may be applied to hold the formed mask in intimate contact with the photoresist-coated article. The masked article may be rotated during exposure to a suitable radiation that effects imaging of the photoresist through the mask. A three-dimensional radiation unit may be used to radiate both the upwardly and sidewardly facing surfaces. For a two-dimensional pattern, a beam of radiation may be directed straight at the masked surface of the article to effect imaging.

Developing involves contacting the imaged photoresist with a developer solvent that selectively removes either the areas of the photoresist coating that have been exposed to the radiation or the unexposed areas, depending on whether a positive or negative photoresist is used. Suitable developers matched to the particular photoresist used are commercially available. The developer is typically maintained at an elevated temperature (e.g., 100 to 105° F.) and is sprayed (under pressure) onto the surfaces of the imaged photoresist.

After the photoresist has been developed, the article, which now has a patterned photoresist layer coated over an electrolessly deposited metal coating, is dried such as in an oven. As the parts are dried, a thin layer of oxide film may be formed on the electrolessly deposited metal layer that is exposed through the patterned photoresist coating. It is highly desirable, or necessary, to eliminate the oxide film (i.e., activate the exposed electrolessly deposited metal) before a subsequent electroplating step. It is also desirable to remove any other contaminants that may have landed on the exposed electrolessly deposited metal layer prior to the electroplating step. Removal of any oxide film and other potential contaminants from the exposed surfaces of the electrolessly deposited metal layer can be achieved by immersing the article in a solution of sulfuric acid (e.g., a 10% solution) before immersing the article in the electroplating bath.

One or more decorative and/or functional metal layers may be electroplated onto the activated exposed surfaces of the electrolessly deposited metal on the article. The decorative and/or functional layers are deposited only on the areas of the electrolessly deposited metal layer that are exposed through the patterned photoresist. The electroplated metal forms a desired decorative pattern or a desired functional pattern, such as an electrical circuit. After the desired decorative or functional metal and/or metal alloy pattern has been electroplated onto the exposed electrolessly deposited metal coating, the remaining photoresist and the electrolessly deposited metal under the photoresist may be stripped away from the surface of the article.

The process of this invention allows intricate and/or fine patterns of metal to be precisely electroplated onto either a two-dimensional or a three-dimensional contoured surface of a plastic article or substrate. For selective decorative plating, various finishes can be provided using the processes of this invention, including satin finishes, platinum, gold, bright nickel and chromium, as well as generally any decorative metal or alloy that can be electroplated onto a conductive substrate (i.e., the electrolessly deposited metal coating).

Decorative applications for the invention include various plastic housings such as for electrical, electronic and/or photographic and/or videographic equipment, e.g., hand held electronic game devices, electronic organizers, personal digital assistance (PDAs), computers, cellular telephones, etc. Functional applications include electrical circuit patterns that are disposed on a three-dimensional circuit carrier.

Three-dimensional electrical circuits can be prepared using the process of this invention, such as by solder electroplating (e.g., SnPb or AgCuSn alloy) over nickel or copper electroplate that is deposited (e.g., electroplated or electrolessly plated) onto the areas of the electrolessly deposited metal coating exposed through the developed photoresist pattern.

In accordance with one aspect of this invention, a decorative chrome pattern is formed by electroplating a bright acid copper onto the exposed surfaces of the electrolessly deposited metal layer (e.g., copper), activating the bright acid copper, electroplating a bright nickel over the activated copper electroplate, and electroplating chromium over the bright nickel plating. After the chromium has been electroplated onto the bright nickel plate, the patterned photoresist layer and the electrolessly deposited metal under the patterned photoresist layer may be removed from the surface of the plastic article to provide a finished plastic part having a desired decorative metal plating pattern, wherein the surface of the plastic article is exposed through the selectively deposited metal pattern.

A commercialized acid copper electroplating process may be used to deposit about 5-10 μm bright copper layer on the exposed copper pattern surface at 24 A/ft² in 15-20 minutes.

Brighteners always adsorb onto the bright acid copper surface, which adversely affects the adhesion of bright nickel plating. Therefore, the copper deposit from the bright acid copper electroplating is preferably activated such as in a solution consisting of from about 5% to about 6% H₂SO₄ by volume+from about 2% to about 3% H₂O₂ by volume at ambient temperature for 30-60 seconds.

Following copper activation and rinse, the parts may be further electroplated with bright nickel and decorative chromium using commercial processes. Bright nickel thickness is typically controlled in a range of 5-10 μm while chromium thickness is typically in a range of 0.05-0.5 μm.

The patterned photoresist and the electroless copper deposit underneath the patterned photoresist may be stripped in a two step process. A commercial stripper for the patterned photoresist may be used. Typically, the stripping operation is carried out by immersing the article having the patterned photoresist in a bath containing the stripper at an elevated temperature (e.g., 120-160° F. with agitation for 3-6 minutes). The electroless copper deposit underneath the patterned photoresist may be stripped in 20-30% CrO₃ by weight+10-20% H₂SO₄ by volume at 120-160° F. for 45-90 seconds, followed by neutralization in a commercial reducing solution at 100° F. for 1-2 minutes to eliminate hexavalent chromium residue on the parts. If a decorative finish other than a bright nickel and chrome plating is used, an appropriate stripper for removing electroless copper deposit should be used to ensure that the stripper does not damage the decorative finish.

Solder alloy electroplating (e.g., SnPb or AgCuSn) may be incorporated in the selective plating on plastic components for functional purposes, for example, a plastic electronic device with a three-dimensional electric circuit configuration. In this case, bright acid copper electroplating is followed by a nickel barrier electroplate of about 0.000030 inch thick and a solder alloy electroplate to attain the deposit thickness specified in a commercially available bath after the acid copper deposit is activated and rinsed sufficiently. A nickel barrier is used to prevent the copper from diffusing into the solder plate at normal soldering temperatures or during product servicing.

Although a commercial stripper may be used for removing the patterned photoresist, the electroless copper deposit underneath the patterned photoresist is preferably stripped using a solution that is adaptable to the solder alloy electrodeposited without adverse effects.

Preferably, there is at least one water rinse between two successive wet steps in the process. Each rinse may be for about 30-60 seconds, and 15-30 seconds of dripping time may be allocated after the article leaves the solution in each wet processing step, including each rinse. The activating treatment prior to electroless copper deposition consists of two steps including either catalyzation and acceleration or sensitization and nucleation (Ag activation process).

In accordance with another aspect of this invention, a decorative metal pattern is formed on a plastic component by electrolessly depositing a metal coating on a surface of the plastic component, depositing a photoresist coating on the electrolessly deposited metal coating, imaging the photoresist coating with a desired pattern, developing the imaged photoresist coating to form a patterned photoresist layer on the plastic component wherein selected surfaces of the electrolessly deposited metal layer are exposed through the patterned photoresist coating, etching the selected surfaces of the electrolessly deposited metal layer that are exposed through the patterned photoresist coating (such as with a CrO₃/H₂SO₄ solution) to remove the electrolessly deposited metal exposed through the patterned photoresist coating by removing the patterned photoresist layer thereby exposing the underlying patterned electrolessly deposited metal, and plating a metal on the patterned electrolessly deposited metal.

In accordance with another aspect of this invention, a clear polyurethane film or topcoat that adheres to both the metal plating and the surface of the plastic substrate is applied. The clear urethane topcoat, in addition to firmly adhering to both the metal and plastic, also restores the gloss and luster of the plastic substrate that is lost during etching.

In accordance with a preferred embodiment of the invention, a clear, hard polyurethane polymer film is deposited on the patterned chrome plating and plastic substrate by first applying an aqueous primer composition to the chrome plating and plastic substrate, and applying a two part urethane composition over the primer composition. The primer composition is comprised, and more preferably consists essentially of, water, methanol, and a silane-coupling agent. The primer composition may be applied to a bright metal surface by spraying, dipping or wiping techniques. Preferably, the bright metal surface is cleaned prior to application of the primer composition. The applied primer composition is allowed to dry. After the primer composition has dried, a liquid urethane composition is applied over the dried primer composition, and is allowed to cure. The urethane composition can be applied by any of various techniques, including spraying, dipping or wiping techniques, with spraying being preferred. A suitable thermal cure can be achieved in about 60 minutes at 180° F. (about 82° C.).

The polyurethane films generally have a thickness of from about 5-200 microns, more typically from 10-100 microns, and preferably from 20-50 microns.

Although a desirable aesthetic finish can be achieved without pigments or dyes, the two-part urethane composition may include a dye, pigment or other colorant or a mixture of colorants to create a desired tinted film.

The urethane composition may be either a one-component urethane system, or preferably a two-component urethane system. A two-component urethane system is a urethane system in which the isocyanate and polyol components are kept separate from one another until just prior to use at which time those components are mixed together and applied to a surface. Upon mixing the two components, a full urethane polymerization reaction occurs. Generally, any of a variety of two-component polyurethane systems that are suitable for forming continuous films may be used in this invention.

### TWO EXAMPLES FOR THE PATENT OF SELECTIVE PLATING

### Example 1

A decorative chrome plating with a specially designed pattern was produced on the contoured surface of a plastic part made of polycarbonate/ABS alloy resin by the following steps described below. The finish is very attractive.

Condition

1. A plastic part made of PC/ABS alloy resin was first immersed in a proprietary conditioner for 1 minute and then thoroughly rinsed in flowing water.

Etch

2. The part was further immersed in an etching solution containing 350 g/L CrO₃+240 ml/L 98% H₂SO₄ at a temperature of 160° F. with agitation for 10 minutes and thoroughly rinsed in flowing water.

Neutralize

3. The etched part was neutralized in a solution containing a reducing agent at 100° F. with agitation for 2 minutes to eliminate the possible hexavalent chromium residue left on the part and then thoroughly rinsed in flowing water.

Catalyze

4. The part was immersed in a palladium-based catalyst bath sold by the Shipley Company at 110° F. for 3 minutes and twice rinsed in two counterflowing water tanks.

Accelerate

5. The part was immersed in an accelerating bath (sold by the Shipley Company) at room temperature for 2 minutes and thoroughly rinsed in flowing water.

Electroless Copper Deposit

6. The part was then immersed in a commercial electroless copper bath (obtained from MacDermid) at 100° F. for 25 minutes. A ca. 50 microinch layer of copper was evenly deposited on the entire surface of the part to serve as conductive layer. The part was twice rinsed in counterflowing city water.

7. Prior to an electrophoretic deposition of photoresist coating, the part was further rinsed in deionized water for at least 1 minute to minimize the possible contamination to the photoresist coating bath.

E-Coat

8. An electrophoretic photoresist coating was deposited on the part in a commercial bath sold by the Shipley Company. The deposition was repeatedly operated at 100° F. and 70-100 V with a 10 V increment and ca. 45 seconds each run. A pin hole free photoresist coating (about 20 μm) was evenly produced on the copper layer of the part surface. The part was rinsed two times in deionized water, one minute in each tank.

Dry

9. After the E-coating and thoroughly rinsing, the part was dried in an oven with particle-free warm air at 80° F. for 15 minutes, baked at 170° F. for 2 minutes after temperature was ramped to the specified temperature at a rate of ca. 20° F./min, and cooled down to room temperature.

Image

10. The E-coated part was mounted on a mold which was used to support the part and connected to a vacuum system. A pre-printed, thermally formed mask with a specially designed pattern covered on the surface of the part. A sufficient vacuum suction force was employed to hold the pre-made mask in an intimate contact with the part surface. The mask-covered part as a whole was exposed to an UV light with wavelength of 365 nm for about 10 seconds. The UV light caused a cross-linked polymerization in the area exposed, resulting in the formation of a desired pattern on the contoured surface of the part.

Develop

11. The imaged part was sprayed with a proprietary developing solution provided by the Shipley Company in a closed tank at 100° F. for about 90 seconds to etch the uncured photoresist coating and thoroughly rinsed in flowing water.

Acid Rinse

12. The part was immersed in a 10% H₂SO₄ solution at ambient temperature for 20 seconds to remove the oxide film and the photoresist residue in the exposed area of electroless copper deposit after imaging development.

Electroplate Copper

13. After rinsing in flowing water, the part was electroplated in a commercial acid copper bath supplied by ProCom at 70° F. and 24 A/ft² for 15 minutes. The part was thoroughly rinsed in flowing water, activated in a solution composed of 5-6% H₂SO₄ by volume+2-3% H₂O₂ by volume at ambient temperature for about 39 seconds, and thoroughly rinsed in flowing water.

Electroplate Nickel

14. The part was then electroplated with bright nickel at 40 A/ft² and 100° F. for 10 minutes using a commercial bath sold by Enthone-OMI and thoroughly rinsed in flowing water.

Electroplate Chrome

15. The part was further electroplated with decorative chromium at 200 A/ft² and 100° F. for 3 minutes using a proprietary bath made in shop. The part was thoroughly rinsed in flowing city water, deionized water and hot deionized water sequentially.

Strip E-Coat

16. The cured photoresist was stripped by immersing the part in a commercial stripper (sold by the Shipley Company) at 140° F. for 5 minutes and thoroughly rinsed in flowing water.

Strip Electroless Copper

17. The part was then immersed in an etching solution consisting of 350 g/L CrO₃+240 ml/L 98% H₂SO₄ at 160° F. for 60 seconds to strip the electroless copper underneath the cured photoresist coating, thoroughly rinsed in flowing water, neutralized in a proprietary solution made in shop at 100° F. for 2 minutes, and thoroughly rinsed again in flowing water.

Dry

18. The part was dried with warm air.

### Example 2

This example demonstrated an application of the invented process in the electronic industry. An electronic circuit was directly fabricated on the interior surface of a plastic shell of an electronic device using this invention, as described as follows.

Etch

1. An ABS plastic part was immersed in an etching solution containing 350 g/L CrO₃+240 ml/L 98% H₂SO₄ at a temperature of 160° F. with sufficient agitation for 8 minutes and thoroughly rinsed in flowing water.

Neutralize

2. The etched part was neutralized in a solution containing a reducing agent at 100° F. with agitation for 2 minutes and thoroughly rinsed in flowing water.

Catalyze

3. The part was immersed in a palladium-based catalyst bath (sold by the Shipley Company) at 110° F. for 3 minutes and twice rinsed in two counterflowing water tanks.

Accelerate

4. The part was immersed in a proprietary accelerating bath sold by the Shipley Company at room temperature for 2 minutes and thoroughly rinsed in flowing water.

Electroless Copper Deposit

5. The part was then immersed in a commercial electroless copper bath (obtained from MacDermid) at 100° F. for 25 minutes. A ca. 50 microinches layer of copper evenly deposited on the entire surface of the part, serving as a conductive layer. The part was twice rinsed in counterflowing city water.

Electroplate Copper

6. The part was further electroplated in a commercial acid copper bath supplied by ProCom at 70° F. and 24 A/ft² for 10 minutes and then thoroughly rinsed in flowing city water and flowing deionized water respectively.

E-Coat

7. At about 10 μm thickness of electrophoretic photoresist coating was uniformly deposited on the part surface in a commercial bath sold by the Shipley Company. The deposition was operated at 100° F. and 80 V for 45 seconds. The part was rinsed two times in deionized water, one minute in each tank.

8. After the E-coating and thoroughly rinsing, the part was dried in an oven with particle-free warm air at 80° F. for 15 minutes, baked at 160° F. for 3 minutes after temperature was ramped to the specified temperature at a rate of ca. 20° F./min., and cooled down to room temperature.

Image

9. The E-coated part was mounted on a mold which was used to support the part and connected to a vacuum system. A pre-printed circuit mask covered on the surface of the part. The mask-covered part as a whole was exposed to an UV light with a wavelength of 365 nm for about 10 seconds to create a desired circuit pattern on the interior surface of the part.

Develop

10. The imaged part was sprayed with a proprietary developing solution provided by the Shipley Company in a closed tank at 100° F. for about 90 seconds to etch the uncured photoresist coating and thoroughly rinsed in flowing water.

Strip Copper

11. The part was then immersed in an etching solution consisting of 350 g/L CrO₃+240 ml/L 98% H₂SO₄ at 160° F. for 60 seconds to strip the electroless copper underneath the uncured photoresist coating, thoroughly rinsed in flowing water, neutralized in a proprietary solution made in shop at 100° F. for 2 minutes, and thoroughly rinsed again in flowing water.

Strip E-Coat

12. The part was further immersed in a commercial stripper sold by the Shipley Company at 140° F. for 5 minutes to strip the cured photoresist, thoroughly rinsed in flowing water, and dried with warm air.

The above description is considered that of the preferred embodiments only. Modifications of the invention will occur to those skilled in the art and to those who make or use the invention. Therefore, it is understood that the embodiments described above are merely for illustrative purposes and not intended to limit the scope of the invention, which is defined by the following claims as interpreted according to the principles of patent law, including the doctrine of equivalents.

The invention claimed is:

1. A process for selectively plating a metal on a plastic component, comprising:
electrolessly depositing a metal layer on a surface of the plastic component;
depositing a photoresist coating on the electrolessly deposited metal layer;
imaging the photoresist coating with a desired pattern;
developing the imaged photoresist coating to form a patterned photoresist layer on the plastic component, wherein selected surfaces of the electrolessly deposited metal layer are exposed through the patterned photoresist layer; and
plating a metal on the electrolessly deposited metal layer that is exposed through the patterned photoresist layer.

2. The process of claim 1, wherein after the imaged photoresist coating has been developed, and before electroplating of a metal on the exposed surfaces of the electrolessly deposited metal layer, the exposed surfaces of the electrolessly deposited metal layer are activated by removing metal oxides from the surface of the exposed electrolessly deposited metal layer.

3. The process of claim 1, wherein the electrolessly deposited metal layer is an electrolessly deposited copper layer.

4. The process of claim 1, wherein the plating of a metal on the electrolessly deposited metal layer exposed through the patterned photoresist is achieved by electroplating.

5. The process of claim 4, wherein the metal that is electroplated onto the electrolessly deposited metal layer is copper.

6. The process of claim 5, wherein a bright nickel is electroplated over the copper electroplate, and a decorative chromium layer is subsequently electroplated over the bright nickel.

7. The process of claim 6, wherein subsequent to deposition of the chromium, the patterned photoresist layer and the electrolessly deposited metal under the patterned photoresist layer are removed from the surface of the plastic component.

8. The process of claim 7, wherein subsequent to removal of the patterned photoresist and electrolessly deposited metal under the patterned photoresist, a polymer film is deposited over both the patterned chrome plate and the surface of the plastic article.

9. The process of claim 8, wherein application of the polymer film comprises:
applying an aqueous primer composition to the chrome plate and plastic surfaces of the article, the primer composition containing a silane adhesion promoter;
drying the applied primer composition;
applying a urethane composition over the chrome plate on which the aqueous primer was applied and dried; and
curing the urethane composition to form polyurethane film.

10. The process of claim 1, further comprising electroplating a solder alloy on the metal plate deposited on the electrolessly deposited metal layer.

11. The process of claim 10, wherein the solder alloy is selected from the group consisting of tin-lead alloy and silver-copper-tin alloy.

12. The process of claim 1, wherein the photoresist is electrophoretically deposited on the surface of the plastic component.

13. The process of claim 1, wherein a pre-formed mask is used to conformally cover the photoresist coated article prior to and during imaging of the photoresist coating.

14. The process of claim 1, wherein the thermally formed mask is secured to the photoresist coated article using a vacuum.

15. The process of claim 1, wherein imaging of the photoresist coating with a desired pattern is achieved by exposing selected sections of the photoresist coating to radiation through a mask.

16. The process of claim 15, wherein the masked article is rotated with respect to a radiation source during exposure of the masked article to the radiation source.

17. The process of claim 15, wherein radiation is directed straight at the masked article.

18. The process of claim 1, wherein the plating of a metal of the electrolessly deposited metal layer exposed through the patterned photoresist is achieved by electroless plating.

19. The process of claim 1, further comprising stripping the cured photoresist coating and the electrolessly deposited metal layer underneath the cured photoresist coating.

20. A selectively plated plastic component made by a process comprising:
electrolessly depositing a metal layer on a surface of the plastic component;
depositing a photoresist coating on the electrolessly deposited metal layer;
imaging the photoresist coating with a desired pattern;
developing the imaged photoresist coating to form a patterned photoresist layer on the plastic component, wherein selected surfaces of the electrolessly deposited metal layer are exposed through the patterned photoresist coating; and
plating a metal on the electrolessly deposited metal layer that is exposed through the patterned photoresist coating.

21. The selectively plated plastic component of claim 20, wherein after the imaged photoresist coating has been developed, and before electroplating of a metal on the exposed surfaces of the electrolessly deposited metal layer, the exposed surfaces of the electrolessly deposited metal layer are activated by removing metal oxides from the surface of the exposed electrolessly deposited metal layer.

22. The selectively plated plastic component of claim 20, wherein the electrolessly deposited metal layer is an electrolessly deposited copper layer.

23. The selectively plated plastic component of claim 20, wherein the plating of a metal on the electrolessly deposited metal layer exposed through the patterned photoresist is achieved by electroplating.

24. The selectively plated plastic component of claim 23, wherein the metal that is electroplated onto the electrolessly deposited metal layer is copper.

25. The selectively plated plastic component of claim 24, wherein a bright nickel is electroplated over the copper electroplate, and a decorative chromium layer is subsequently electroplated over the bright nickel.

26. The selectively plated plastic component of claim 25, wherein subsequent to deposition of the chromium, the patterned photoresist layer and the electrolessly deposited metal under the patterned photoresist layer are removed from the surface of the plastic component.

27. The selectively plated plastic component of claim 26, wherein subsequent to removal of the patterned photoresist and electrolessly deposited metal under the patterned photoresist, a polymer film is deposited over both the patterned chrome plate and the surface of the plastic article.

28. The selectively plated plastic component of claim 27, wherein application of the polymer film comprises:
applying an aqueous primer composition to the chrome plate and plastic surfaces of the article, the primer composition containing a silane adhesion promoter;
drying the applied primer composition;
applying a urethane composition over the chrome plate on which the aqueous primer was applied and dried; and
curing the urethane composition to form polyurethane film.

29. The selectively plated plastic component of claim 20, further comprising electroplating a solder alloy on the metal plate deposited on the electrolessly deposited metal layer.

30. The selectively plated plastic component of claim 29, wherein the solder alloy is selected from the group consisting of tin-lead alloy and silver-copper-tin alloy.

31. The selectively plated plastic component of claim 20, wherein the photoresist is electrophoretically deposited on the surface of the plastic component.

32. The selectively plated plastic component of claim 20, wherein a pre-formed mask is used to conformally cover the photoresist coated article prior to and during imaging of the photoresist coating.

33. The selectively plated plastic component of claim 20, wherein the thermally formed mask is secured to the photoresist coated article using a vacuum.

34. The selectively plated plastic component of claim 20, wherein imaging of the photoresist coating with a desired pattern is achieved by exposing selected sections of the photoresist coating to radiation through a mask.

35. The selectively plated plastic component of claim 34, wherein the masked article is rotated with respect to a radiation source during exposure of the masked article to the radiation source.

36. The selectively plated plastic component of claim 34, wherein radiation is directed straight at the masked article.

37. The selectively plated plastic component of claim 20, wherein the plating of a metal of the electrolessly deposited metal layer exposed through the patterned photoresist is achieved by electroless plating.

38. The selectively plated plastic component of claim 20, further comprising stripping the cured photoresist coating and the electrolessly deposited metal layer underneath the cured photoresist coating.

39. A process for selectively plating on a plastic component, comprising:
electrolessly depositing a metal layer on a surface of the plastic component;
depositing a photoresist coating on the electrolessly deposited metal coating;
imaging the photoresist coating with a desired pattern;
developing the imaged photoresist coating to form a patterned photoresist layer on the plastic component, wherein selected surfaces of the electrolessly deposited metal layer are exposed through the patterned photoresist coating;
etching the selected surfaces of the electrolessly deposited metal layer that are exposed through the patterned photoresist coating to remove the electrolessly deposited metal layer exposed through the patterned photoresist coating;
removing the patterned photoresist layer to expose an underlying patterned electrolessly deposited metal layer; and
plating a metal on the patterned electrolessly deposited metal layer.

40. The process of claim 39, wherein after the imaged photoresist coating has been developed, and before electroplating of a metal on the exposed surfaces of the electrolessly deposited metal layer, the exposed surfaces of the electrolessly deposited metal layer are activated by removing metal oxides from the surface of the exposed electrolessly deposited metal layer.

41. The process of claim 39, wherein the electrolessly deposited metal layer is an electrolessly deposited copper layer.

42. The process of claim 39, wherein the plating of a metal on the electrolessly deposited metal layer exposed through the patterned photoresist is achieved by electroplating.

43. The process of claim 42, wherein the metal that is electroplated onto the electrolessly deposited metal layer is copper.

44. The process of claim 43, wherein a bright nickel is electroplated over the copper electroplate, and a decorative chromium layer is subsequently electroplated over the bright nickel.

45. The process of claim 44, wherein subsequent to deposition of the chromium, the patterned photoresist layer and the electrolessly deposited metal under the patterned photoresist layer are removed from the surface of the plastic component.

46. The process of claim 45, wherein subsequent to removal of the patterned photoresist and electrolessly deposited metal under the patterned photoresist, a polymer film is deposited over both the patterned chrome plate and the surface of the plastic article.

47. The process of claim 46, wherein application of the polymer film comprises:
applying an aqueous primer composition to the chrome plate and plastic surfaces of the article, the primer composition containing a silane adhesion promoter;
drying the applied primer composition;
applying a urethane composition over the chrome plate on which the aqueous primer was applied and dried; and
curing the urethane composition to form polyurethane film.

48. The process of claim 39, further comprising electroplating a solder alloy on the metal plate deposited on the electrolessly deposited metal layer.

49. The process of claim 48, wherein the solder alloy is selected from the group consisting of tin-lead alloy and silver-copper-tin alloy.

50. The process of claim 39, wherein the photoresist is electrophoretically deposited on the surface of the plastic component.

51. The process of claim 39, wherein a pre-formed mask is used to conformally cover the photoresist coated article prior to and during imaging of the photoresist coating.

52. The process of claim 39, wherein the thermally formed mask is secured to the photoresist coated article using a vacuum.

53. The process of claim 39, wherein imaging of the photoresist coating with a desired pattern is achieved by exposing selected sections of the photoresist coating to radiation through a mask.

54. The process of claim 53, wherein the masked article is rotated with respect to a radiation source during exposure of the masked article to the radiation source.

55. The process of claim 53, wherein radiation is directed straight at the masked article.

56. The process of claim 39, wherein the plating of a metal of the electrolessly deposited metal layer exposed through the patterned photoresist is achieved by electroless plating.

57. The process of claim 39, further comprising stripping the cured photoresist coating and the electrolessly deposited metal layer underneath the cured photoresist coating.
